(19) United States
(12) Patent Application Publication
(10) Pub. No.: US 2002/0187391 A1
(43) Pub. Date: Dec. 12, 2002

(54) Anode cans for electrochemical cells

(76) Inventors: Keith E. Buckle, Southbury, CT (US); Masaaki Ishio, Osaka (JP)

Correspondence Address: ROBERT C. NABINGER, Fish & Richardson P.C., 225 Franklin Street, Boston, MA, 02110-2804, US

(21) Appl. No.: 09/878,748

(22) Filed: Jun. 11, 2001

(51) Int. Cl. H01M 2/02; B21C 23/24; B21D 11/10

(52) U.S. Cl. 429/176; 72/47; 72/379.4

(57) ABSTRACT

An anode can for an electrochemical cell is disclosed. The anode can is no more than 0.0050 inch thick, and the can includes a copper layer and a stainless steel layer. The ratio of the copper layer thickness to the stainless steel layer thickness is at least 0.10:1.

### BACKGROUND

This invention generally relates to an anode can for a metal air electrochemical cell.

Batteries are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

One example of a battery is a zinc air button cell. The container of a zinc air button cell includes an anode can and a cathode can; the anode can and the cathode can are crimped together to form the container for the cell. During use, oxygen, which is supplied to the cathode from the atmospheric air external to the cell, is reduced at the cathode, and zinc is oxidized at the anode. The zinc contained in the anode can react with the metal components in the anode can, leading to the formation of hydrogen gas. The formation of hydrogen gas can in turn cause electrolyte to leak from the cell. Hydrogen gas evolution can be reduced by including mercury in the anode, but the inclusion of mercury raises environmental concerns.

In addition, it is often desirable to prepare cells using thin-walled anode cans, so additional active components can be added to the cell. But when thin-walled cans are prepared using commercially available materials, often significant levels of hydrogen gas are produced, even when mercury is added to the cells.

### SUMMARY

The anode can of the invention is a thin-walled can, i.e., it has an overall thickness of no more than 0.0050 inch. The can has a stainless steel layer that provides strength and a copper layer that provides a barrier between the stainless steel and the anode active materials.

In one aspect, the invention features an anode can for an electrochemical cell, where the anode can is no more than 0.0050 inch thick. The can includes a copper layer and a stainless steel layer; the ratio of the copper layer thickness to the stainless steel layer thickness is at least 0.10:1.

The copper layer shields the stainless steel from the anode components. During manufacture of the multi-layered metal sheet from which the anode can is made, some of the metals from the stainless steel can migrate into the copper layer. A relatively thick copper layer helps to ensure that there is a sufficient copper barrier between the metals of the stainless steel and the anode, even if migration occurs. The copper layer thus minimizes the formation of hydrogen gas.

The thickness of the copper layer, relative to the stainless steel layer can be varied. For example, the ratio of the copper layer thickness to the stainless steel layer thickness can be at least 0.12:1, at least 0.15:1, at least 0.17:1, or at least 0.20:1. The total thickness of the can may also be varied. The can may be, for example, no more than 0.0040 inch thick, or no more than 0.0025 inch thick.

In another aspect, the invention features an anode can for an electrochemical cell, where the anode can is no more than 0.0050 inch thick. The can has a stainless steel layer and a copper layer with a thickness of at least 0.010 mm.

In another aspect, the invention features an anode can for an electrochemical cell, where the anode can is no more than 0.0050 inch thick. The can has two adjacent copper layers and a stainless steel layer, and the ratio of the thickness of the combined copper layers to the thickness of the stainless steel layer is at least 0.10:1.

In another aspect, the invention features a method of making an anode can for an electrochemical cell. The method includes: (a) attaching a copper layer to a stainless steel layer to form a multi-layered sheet, where the ratio of the copper layer thickness to the stainless steel layer thickness is at least 0.10:1; (b) punching a disk from the multi-layered sheet; and (c) drawing the disk into a can having a thickness of no more than 0.0050 inch. In some embodiments, the method further includes attaching a second copper layer to at least a portion of the drawn anode can to form a finished anode can.

In yet another aspect, the invention features a method of making an anode can for an electrochemical cell. The method includes: (a) attaching a copper layer to a stainless steel layer to form a multi-layered sheet, wherein the thickness of the copper layer is at least 0.010 mm; (b) punching a disk from the multi-layered sheet; and (c) drawing the disk into a can having a thickness of no more than 0.0050 inch.

In another aspect, the invention features a method of making an anode can for an electrochemical cell. The method includes: (a) attaching a first copper layer to a stainless steel layer to form a multi-layered sheet; (b) punching a disk from the multi-layered sheet; (c) drawing the disk into a can; and (d) attaching a second copper layer to at least a portion of the drawn anode can to form a finished anode can having a thickness of no more than 0.0050 inch. The ratio of (i) the combined thickness of the first and second copper layers to (ii) the thickness of the stainless steel layer is at least 0.10:1.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a side sectional view of a button cell.

FIGS. 2 and 3 are sectional views of multi-clad metal sheets.

FIG. 4 is a graph showing gassing rates of different copper surfaces.

FIG. 5 is a graph showing gas pressure inside aged zinc air cells.

### DETAILED DESCRIPTION

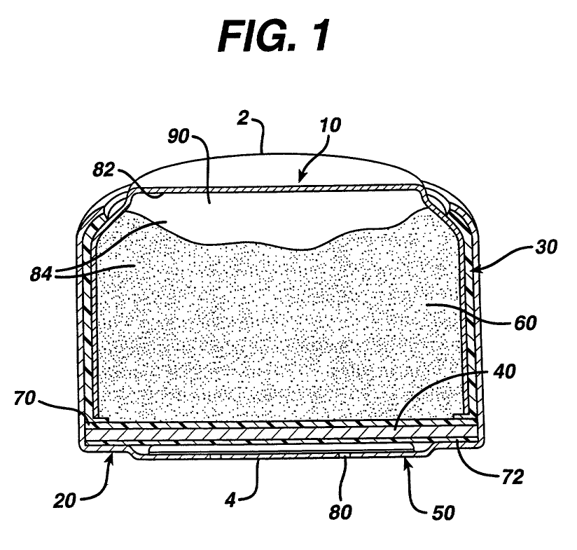

A zinc air cell can be, for example, a button cell. Referring to FIG. 1, a button cell includes an anode side 2 and a cathode side 4. Anode 2 includes anode can 10 and anode gel 60. Cathode 4 includes cathode can 20 and cathode structure 40. Insulator 30 is located between anode can 10 and cathode can 20. Separator 70 is located between cathode structure 40 and anode gel 60, preventing electrical contact between these two components.

Membrane 72 helps prevent the electrolyte from leaking out of the cell. Air access port 80, located in cathode can 20, allows air to exchange into and out of the cell. Air disperser 50 is located between air access port 80 and cathode structure 40.

Anode can 10 and cathode can 20 are crimped together to form the cell container, which has an internal volume, or cell volume. Together, inner surface 82 of anode can 10 and separator 70 form anode volume 84. Anode volume 84 contains anode gel 60. The remainder of anode volume 84 is void volume 90.

The overall thickness of the anode can is no more than 0.0050 inch (0.13 mm). For example, it can be no more than 0.0040 inch (0.10 mm), or no more than 0.0025 inch (0.064 mm). When relatively thin anode cans are used, more active material can be placed in the cell, while still maintaining the same exterior dimensions of the cell. Additional active materials allow for longer cell life. The cans may be thinner than the examples described herein; for example, the cans may be as thin as 0.0020 inch (0.051 mm). Generally, the cans should not be so thin that they collapse during the structural stresses placed on them during the cell manufacturing process.

The anode can may be made of a bi-clad material, a tri-clad material, or a multi-clad material. The bi-clad material is generally stainless steel with an inner surface of copper. The stainless steel provides strength, which is necessary to maintain structural integrity during battery manufacture. The stainless steel can be any stainless steel that can be formed into the proper shape for anode cans at high speeds. Generally, stainless steel that is available as a thin foil is used. For example, 304 stainless steel, as described in ASTM A167 can be used. Alternatively, SUS 15-14 Stainless Steel, as described in the Japanese Institute of Standards, can be used. Generally, the layer of stainless steel makes up about 70 to about 90 percent of the total thickness of the anode can.

The copper layer provides a barrier between the stainless steel layer and the anode, and thus minimizes the formation of hydrogen gas. The copper can be pure copper. By “pure copper” is meant copper that fits the requirements described in ASTM F68. Generally, “pure copper” is at least 99.99% copper. For example, Ultrapure OFC grade copper, available from Hitachi Cable Ltd, Tokyo, Japan, can be used.

The copper layer is thick enough to reduce gassing to within acceptable limits. Generally, the copper layer is at least 0.010 mm thick. When the biclad material is formed, it is sometimes annealed at temperatures of 1000-1050° C., which is just below the melting point of copper. These high temperatures can cause heavy metals, such as iron and chromium, from the stainless steel to migrate partway into the copper layer. Thus, if the copper layer is too thin, the heavy metals can come into contact with the anode active material.

The copper layer can be thicker than the layers described in the examples herein. For example, the copper layer can be at least 0.015 mm thick, or at least 0.020 mm thick.

Similarly, the ratio of the copper layer thickness to the stainless steel layer thickness can be higher than the examples described herein. But the copper layer is generally not so thick that the anode volume becomes too small to contain an adequate amount of anode active material.

In addition, the copper layer is generally not so thick that the stainless steel layer becomes correspondingly too thin to maintain structural integrity of the anode can during manufacture of the anode can and of the finished cell.

The anode can may also be made of tri-clad material. A can made of triclad material has a stainless steel layer with a copper layer on the inner surface of the can and a nickel layer on the outer surface of the can. The nickel provides an aesthetically pleasing outer surface. The layer of nickel generally takes up only a small proportion of the total thickness of the can. For example, the ratio of the combined thickness of the stainless steel and the copper to the thickness of the layer of nickel can be about 49:1. As is the case with the biclad material, the stainless steel usually makes up about 70-90% of the thickness of the can. In addition, the ratio of the thickness of the copper layer to the thickness of the stainless steel layer is at least 0.10:1.

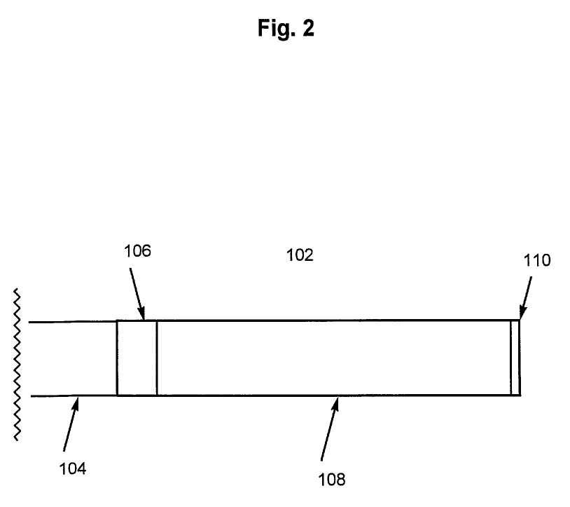

Referring to FIG. 2, a cross-section of an anode can 102 is shown. The copper layer 106 provides a barrier between the anode cavity 104 and the stainless steel layer 108. The exterior of the can is coated with a nickel layer 110.

The anode cans may be prepared as follows. The biclad or triclad material is prepared using standard manufacturing techniques. Disks are then punched from the biclad or triclad material. By “disk” is meant a piece of metal with relatively smooth edges. The shape of the disk will depend on the shape of the cell for which it is intended. For example, if the anode can is for a button cell, the disk will be generally circular. If the anode can is for a prismatic cell, the disk may be rectangular.

The disks are drawn into anode cans. In some embodiments, at least a portion of the surface of the drawn anode can is coated with an additional layer of copper. The additional layer can be, for example, about 0.0010 to about 0.015 mm thick. The anode can may be post plated with an additional layer of copper using solution coating (electroless) techniques, vacuum techniques, or electrolytic barrel plating techniques, such as those described in F. A. Lowenheim, Modem Electroplating (John Wiley and Sons, New York, 1974) and the Metal Finishing Guidebook and Directory (Metal Finishing, Elsevier Publishing, New York, 1992). This plating procedure is also described in more detail in U.S. Ser. No. 09/829,710, filed Apr. 10, 2001. After the plating step, the plated anode cans may be heat treated, e.g., by passing a reducing gas over the anode cans in a quartz furnace at 500° C. for 20 minutes.

When the anode can is post plated with copper, the copper layer on the interior of the can obviously becomes thicker, due to the additional layer of copper. In such cases, the thickness of the final copper layer, which is composed of the original copper layer and the post plated layer, can be at least 0.010 mm thick. Alternatively, the ratio of the thickness of the final copper layer to the stainless steel layer can be at least 0.10:1.

In some embodiments, commercially available triclad materials, in which the thickness of the copper layer is less than 0.010 mm, or in which the ratio of copper layer thickness to the stainless steel layer thickness, are used. This material is shaped into anode cans, and the anode cans are post plated with copper, such that the final layer of copper on the interior of the cans is at least 0.010 mm thick, or such that the ratio of the final copper layer thickness to the stainless steel layer thickness is at least 0.10:1. Such embodiments are meant to be included in the invention disclosed herein.

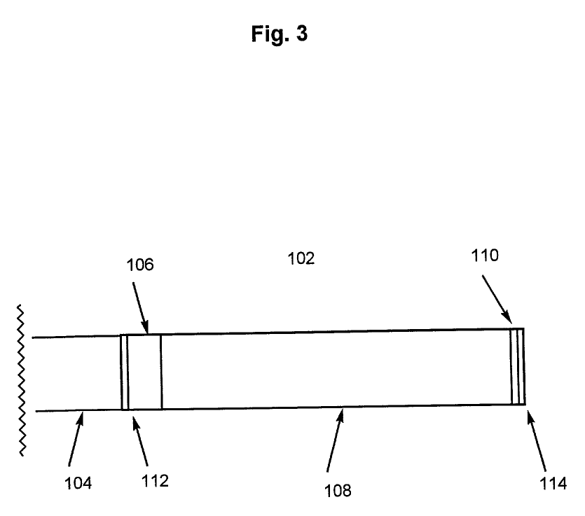

Referring to FIG. 3, a cross-section of a post plated anode can 102 is shown. The copper layer includes layer 106 and post plated layer 112. Together, layer 106 and layer 112 are at least 0.010 mm thick. Alternatively, the ratio between the combined thickness of layers 106 and 112 and the thickness of stainless steel layer 108 is at least 0.10:1. Copper layers 106 and 112 provide a barrier between the anode cavity 104 and the stainless steel layer 108. The exterior of the can is coated with a layer of nickel 110 and a layer of copper 114.

Cans in which the metal working, e.g., punching and shaping, and plating steps are complete are referred to herein as “finished” cans. It is to be understood that a “finished” can might still need to be cleaned and/or polished before being included in an electrochemical cell.

The cathode can is composed of cold-rolled steel having inner and outer layers of nickel. There is an insulator, such as an insulating gasket, that is pressure-fit between the anode can and cathode can. The gasket can be thinned to increase the capacity of the cell.

The anode can and the cathode can, together, form the cell container. Overall cell height and diameter dimensions for the cells are specified by the International Electrotechnical Commission (IEC). A button cell can have a variety of sizes: a 675 cell (IEC designation “PR44”) has a diameter between about 11.25 and 11.60 millimeters and a height between about 5.0 and 5.4 millimeters; a 13 cell (IEC designation “PR48”) has a diameter between about 7.55 and 7.9 millimeters and a height between about 5.0 and 5.4 millimeters; a 312 cell (IEC designation “PR41”) has a diameter between about 7.55 and 7.9 millimeters and a height of between about 3.3 and 3.6 millimeters; and a 10 cell (IEC designation “PR70”) has a diameter between about 5.55 and 5.80 millimeters and a height between about 3.30 and 3.60 millimeters. A 5 cell has a diameter between about 5.55 and 5.80 millimeters and a height between about 2.03 and 2.16 millimeters.

The cathode structure has a side facing the anode gel and a side facing the air access ports. The side of the cathode structure facing the anode gel is covered by a separator. The separator can be a porous, electrically insulating polymer, such as polypropylene, that allows the electrolyte to contact the air cathode. The side of the cathode structure facing the air access ports is typically covered by a polytetrafluoroethylene (PTFE) membrane that can help prevent drying of the anode gel and leakage of electrolyte from the cell. Cells can also include an air disperser, or blotter material, between the PTFE membrane and the air access ports. The air disperser is a porous or fibrous material that helps maintain an air diffusion space between the PTFE membrane and the cathode can.

The cathode structure includes a current collector, such as a wire mesh, upon which is deposited a cathode mixture. The wire mesh makes electrical contact with the cathode can. The cathode mixture includes a catalyst for reducing oxygen, such as a manganese compound. The catalyst mixture is composed of a mixture of a binder (e.g., PTFE particles), carbon particles, and manganese compounds The catalyst mixture can be prepared, for example, by heating manganese nitrate or by reducing potassium permanganate to produce manganese oxides, such as Mn₂O₃, Mn₃O₄, and MnO₂.

The catalyst mixture can include between about 15 and 45 percent polytetrafluoroethylene by weight. For example, the cathode structure can include about 40 percent PTFE, which can make the structure more moisture resistant, reducing the likelihood of electrolyte leakage from the cell. The cathode structure can have an air permeability without a separator and with one layer of PTFE film laminated on the screen of between about 300 and 600 sec/in², preferably about 400 sec/in², with 10 cubic centimeters of air. The air permeability can be measured using a Gurley Model 4150. The air permeability of the cathode structure can control venting of hydrogen gas in the cells, releasing the pressure, improving cell performance, and reducing leakage.

The anode is formed from an anode gel and an electrolyte. The anode gel contains a zinc material and a gelling agent. The zinc material can be a zinc alloy powder that includes less than 3 percent mercury, preferably no added mercury. The zinc material can be is alloyed with lead, indium, or aluminum. For example, the zinc can be alloyed with between about 400 and 600 ppm (e.g., 500 ppm) of lead, between 400 and 600 ppm (e.g., 500 ppm) of indium, or between about 50 and 90 ppm (e.g., 70 ppm) aluminum. Preferably, the zinc material can include lead, indium and aluminum, lead and indium, or lead and bismuth. Alternatively, the zinc can include lead without other metal additive. The zinc material can be air blown or spun zinc. Suitable zinc particles are described, for example, in U.S. Ser. No. 09/156,915, filed Sep. 18, 1998, U.S. Ser. No. 08/905,254, filed Aug. 1, 1997, and U.S. Ser. No. 09/115,867, filed Jul. 15, 1998, each of which is incorporated by reference in its entirety. The zinc can be a powder. The particles of the zinc can be spherical or nonspherical. For example, the zinc particles can be acicular in shape (having an aspect ratio of at least two).

The zinc material includes a majority of particles having sizes between 60 mesh and 325 mesh. For example, the zinc material can have the following particle size distribution:

0-3 wt % on 60 mesh screen;

40-60 on 100 mesh screen;

30-50 wt % on 200 mesh screen;

0-3 wt % on 325 mesh screen; and

0-0.5 wt % on pan.

Suitable zinc materials include zinc available from Union Miniere (Overpelt, Belgium), Duracell (U.S.A.), Noranda (U.S.A.), Grillo (Germany), or Toho Zinc (Japan).

Zinc-air anode materials are loaded into a cell in the following manner. A gelling agent and zinc powder are mixed to form a dry anode blend. The blend is then dispensed into the anode can and the electrolyte is added to form the anode gel.

The gelling agent is an absorbent polyacrylate. The absorbent polyacrylate has an absorbency envelope of less than about 30 grams of saline per gram of gelling agent, measured as described in U.S. Pat. No. 4,541,871, incorporated herein by reference. The anode gel includes less than 1 percent of the gelling agent by dry weight of zinc in the anode mixture. Preferably the gelling agent content is between about 0.2 and 0.8 percent by weight, more preferably between about 0.3 and 0.6 percent by weight, and most preferably about 0.33 percent by weight. The absorbent polyacrylate can be a sodium polyacrylate made by suspension polymerization. Suitable sodium polyacrylates have an average particle size between about 105 and 180 microns and a pH of about 7.5. Suitable gelling agents are described, for example, in U.S. Pat. No. 4,541,871, U.S. Pat. No. 4,590,227, or U.S. Pat. No. 4,507,438.

In certain embodiments, the anode gel can include a non-ionic surfactant, and an indium or lead compound, such as indium hydroxide or lead acetate. The anode gel can include between about 50 and 500 ppm, preferably between 50 and 200 ppm, of the indium or lead compound. The surfactant can be a non-ionic phosphate surfactant, such as a nonionic alkyl phosphate or a non-ionic aryl phosphate (e.g., RA600 or RM510, available from Rohm & Haas) coated on a zinc surface. The anode gel can include between about 20 and 100 ppm the surfactant coated onto the surface of the zinc material. The surfactant can serve as a gassing inhibitor.

The electrolyte can be an aqueous solution of potassium hydroxide. The electrolyte can include between about 30 and 40 percent, preferably between 35 and 40 of potassium hydroxide. The electrolyte can also include between about 1 and 2 percent of zinc oxide.

During storage, the air access ports are typically covered by a removable sheet, commonly known as the seal tab, that is provided on the bottom of the cathode can to cover the air access ports to restrict the flow of air between the interior and exterior of the button cell. The user peels the seal tab from the cathode can prior to use to allow oxygen from air to enter the interior of the button cell from the external environment.

The invention is further described in the following examples, which do not limit the scope of the invention described in the claims.

### EXAMPLE 1

### Experimental Determination of Gas Production

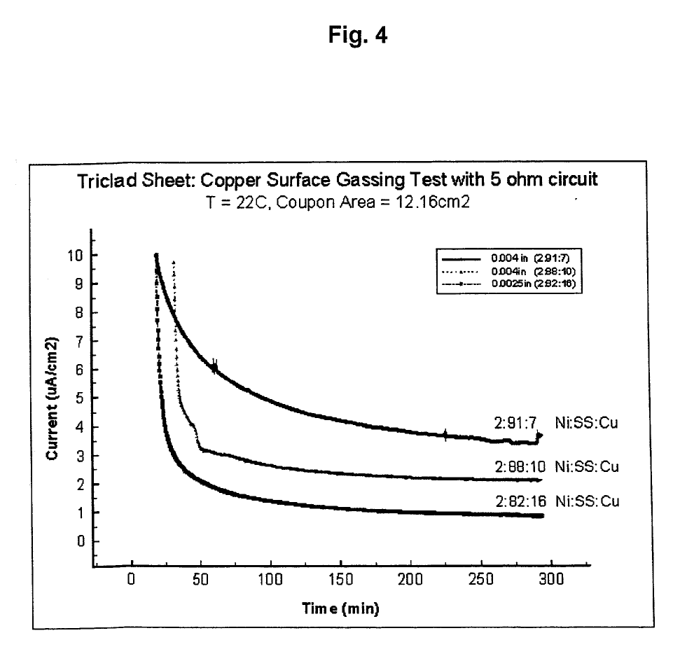

Triclad sheets with copper layers of differing thicknesses were tested in a simulated battery fixture to determine the amount of hydrogen gas that would be produced if the sheets were used to prepare anode cans for cells. Two 0.0040 inch sheets were tested, and one 0.0025 inch sheet was tested. The first 0.0040 inch sheet had a ratio of nickel:stainless steel:copper of 1:91:7, and the second 0.0040 inch sheet had a ratio of 2:88:10. The 0.0025 inch sheet had a nickel:stainless steel:copper ratio of 2:82:16. In FIG. 4, the measured current is proportional to the amount of gas generated. Thus, the higher the current, the more gas that is generated.

As shown in FIG. 4, the sheet with the thinnest copper layer had the highest gassing level curve, indicating that a cell made using this material would produce the most hydrogen gas. The sheets with thicker copper layers had lower gassing rates. These results demonstrate that even when the overall thickness of the anode can is reduced, it is important to maintain at least a minimum thickness of the copper layer.

### EXAMPLE 2

### Gas Production in Stored Cells

Two different triclad materials were used to form anode cans. The anode cans were then used to form zinc air button cells. The first material had layer of copper that was 0.007 mm thick, and the second material had a layer of copper that was 0.010 mm thick. The gas pressure was measured 7 days after battery manufacture.

Zinc air button cells often have negative gas pressures after being stored for a period of time, because the oxygen trapped inside the cells gets consumed in a self discharge reaction. A gas pressure that is only slightly negative, or a gas pressure that is positive, thus indicates that hydrogen gas is being produced at a rate that competes with the rate of oxygen gas consumption.

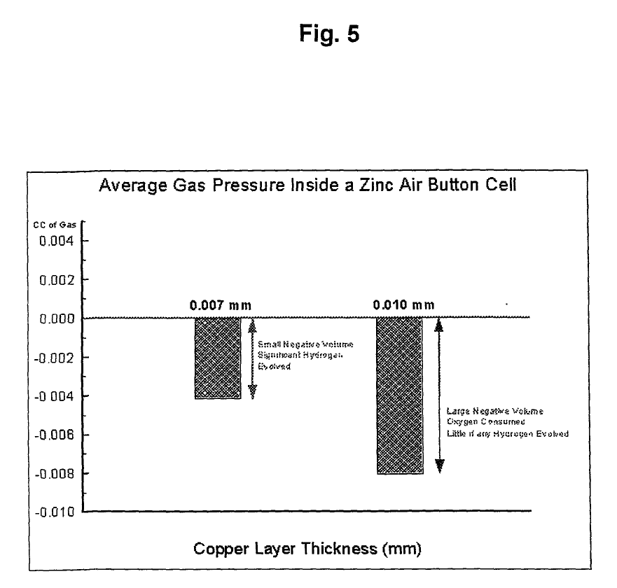

As shown in FIG. 5, the cell made with the triclad material having a layer of copper 0.0070 mm thick had a small negative volume, which indicates that a significant amount of hydrogen gas is produced. The cell made with the triclad material with a layer of copper 0.010 mm thick had a large negative volume, indicating that little, if any, hydrogen gas was produced.

All publications, patents, and patent applications mentioned in this application are herein incorporated by reference to the same extent as if each individual publication, patent, or patent application was specifically and individually indicated to be incorporated by reference.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. An anode can for an electrochemical cell, the anode can being no more than 0.0050 inch thick, wherein the anode can comprises a copper layer and a stainless steel layer, and wherein the ratio of the copper layer thickness to the stainless steel layer thickness is at least 0.10:1.

2. The can of claim 1, wherein the ratio of the copper layer thickness to the stainless steel layer thickness is at least 0.12:1

3. The can of claim 1, wherein the ratio of the copper layer thickness to the stainless steel layer thickness is at least 0.15:1.

4. The can of claim 1, wherein the ratio of the copper layer thickness to the stainless steel layer thickness is at least 0.17:1.

5. The can of claim 1, wherein the ratio of the copper layer thickness to the stainless steel layer thickness is at least 0.20:1.

6. The can of claim 1, wherein the can is no more than 0.0040 inch thick.

7. The can of claim 1, wherein the can is no more than 0.0025 inch thick.

8. The can of claim 1, wherein the copper layer consists essentially of pure copper.

9. The can of claim 1, wherein the stainless steel layer comprises 304 stainless steel.

10. The can of claim 9, wherein the stainless steel layer consists essentially of 304 stainless steel.

11. The can of claim 1, wherein the can includes a nickel layer.

12. The can of claim 11, wherein the ratio of (a) the combined thickness of the stainless steel layer and the copper layer and (b) the thickness of the nickel layer is about 49:1.

13. The can of claim 1, wherein the electrochemical cell is a metal air cell.

14. The can of claim 13, wherein the metal air cell is a zinc air cell.

15. The can of claim 14, wherein the zinc air cell is a button cell.

16. An anode can for an electrochemical cell, the anode can being no more than 0.0050 inch thick, wherein the anode can comprises a stainless steel layer and a copper layer, and wherein the copper layer is at least 0.010 mm thick.

17. The can of claim 16, wherein the can is no more than 0.0040 inch thick.

18. The can of claim 17, wherein the can is no more than 0.0025 inch thick.

19. An anode can for an electrochemical cell, the anode can being no more than 0.0050 inch thick, wherein the anode can comprises two adjacent copper layers and a stainless steel layer, and wherein the ratio of the thickness of the combined copper layers to the thickness of the stainless steel layer is at least 0.10:1.

20. A method of making an anode can for an electrochemical cell, the method comprising:
(a) attaching a copper layer to a stainless steel layer to form a multi-layered sheet, wherein the ratio of the copper layer thickness to the stainless steel layer thickness is at least 0.10:1;
(b) punching a disk from the multi-layered sheet; and
(c) drawing the disk into a can, wherein the thickness of the drawn anode can is no more than 0.0050 inch.

21. The method of claim 20, wherein the method further comprises attaching a second copper layer to at least a portion of the drawn anode can to form a finished anode can.

22. The method of claim 21, wherein the thickness of the finished anode can is no more than 0.0050 inch.

23. The method of claim 22, wherein the ratio of the (a) the combined thickness of the first and second copper layers to (b) the thickness of the stainless steel layer is at least 0.10:1.

24. The method of claim 23, wherein the ratio of (a) the combined thickness of the first and second copper layers to (b) the thickness of the stainless steel layer is at least 0.15:1.

25. The method of claim 24, wherein the ratio of (a) the combined thickness of the first and second copper layers to (b) the thickness of the stainless steel layer is at least 0.20:1.

26. A method of making an anode can for an electrochemical cell, the method comprising:
(a) attaching a copper layer to a stainless steel layer to form a multi-layered sheet, wherein the thickness of the copper layer is at least 0.010 mm;
(b) punching a disk from the multi-layered sheet; and
(c) drawing the disk into a can, wherein the thickness of the drawn anode can is no more than 0.0050 inch.

27. The method of claim 26, wherein the thickness of the drawn anode can is no more than 0.0025 inch.

28. The method of claim 26, wherein the method further comprises attaching a second copper layer to at least a portion of the drawn anode can to form a finished anode can.

29. The method of claim 28, wherein the thickness of the finished anode can is no more than 0.0050 inch thick.

30. A method of making an anode can for an electrochemical cell, the method comprising:
(a) attaching a first copper layer to a stainless steel layer to form a multi-layered sheet;
(b) punching a disk from the multi-layered sheet;
(c) drawing the disk into a can; and
(d) attaching a second copper layer to at least a portion of the drawn anode can to form a finished anode can having a thickness of no more than 0.0050 inch, wherein the ratio of (a) the combined thickness of the first and second copper layers to (b) the thickness of the stainless steel layer is at least 0.10:1.
